(19) United States
(12) Patent Application Publication
(10) Pub. No.: US 2026/0180604 A1
(43) Pub. Date: Jun. 25, 2026

(54) POWER AMPLIFIER, AMPLIFICATION METHOD, AND TRANSMITTER

(71) Applicant: Renesas Electronics Corporation, Tokyo (JP)

(72) Inventors: Yuichi KUSAKA, Tokyo (JP); Noriaki MATSUNO, Tokyo (JP)

(73) Assignee: Renesas Electronics Corporation, Tokyo (JP)

(21) Appl. No.: 19/401,746

(22) Filed: Nov. 26, 2025

(30) Foreign Application Priority Data
Dec. 20, 2024 (JP) 2024-225142

(51) Int. Cl. H04B 1/04; H04W 52/52

(52) U.S. Cl. CPC H04B 1/04; H04W 52/52; H04B 2001/0408

(57) ABSTRACT

A power amplifier that includes a power amplifier core unit that is capable of performing amplitude control in discrete integer steps, and a variable attenuator. The power amplifier core unit performs the amplitude control to reproduce an envelope of an RF signal. The variable attenuator changes an attenuation amount, and controls average transmission power by using a combination of the amplitude control performed by the power amplifier core unit and the attenuation amount of the variable attenuator.

### CROSS-REFERENCE TO RELATED APPLICATION

This application claims priority under 35 U.S.C. § 119 to Japanese Patent Application 2024-225142 filed on Dec. 20, 2024. The disclosure of Japanese Patent Application No. 2024-225142, including the specification, drawings and abstract is incorporated herein by reference in its entirety.

### BACKGROUND

The present disclosure relates to a power amplifier, an amplification method, and a transmitter.

There are disclosed techniques listed below.
[Non-Patent Document 1] F. Raab, “Intermodulation distortion in Khan-technique transmitters”, IEEE Trans. Microwave Theory Tech., vol. 44, pp. 2273-2278, Dec. 1996.
[Non-Patent Document 2] S-M. Yoo, et al. “A switched-capacitor RF power amplifier”, IEEE J. Solid-State Circuits, vol. 46, no. 12, pp. 2977-2987, Dec. 2011.

Non-Patent Document 1 discloses the envelope elimination and restoration (referred to as EER) technique.

Non-Patent Document 2 discloses the switched-capacitor power amplifier (referred to as SCPA) technique.

### SUMMARY

It has been desired that the efficiency of a power amplifier (referred to as PA in some cases) be improved.

Other problems and novel features will become apparent from the description of this specification and the accompanying drawings.

According to an embodiment, a power amplifier includes a power amplifier core unit that is capable of performing amplitude control in discrete integer steps, and a variable attenuator.

According to an embodiment, an amplification method includes a step of performing amplitude control in discrete integer steps by using a power amplifier core unit, and a step of changing an attenuation amount by using a variable attenuator.

According to an embodiment, a transmitter includes: a phase-amplitude separation circuit that separates a baseband signal into a phase signal and an amplitude signal, the phase signal being a phase component of the baseband signal, the amplitude signal being an amplitude component of the baseband signal; a phase modulation block that modulates an RF carrier signal with the phase signal to generate a first RF signal that has been phase-modulated; a power amplifier core unit that is capable of performing amplitude control in discrete integer steps; and a variable attenuator. The power amplifier core unit performs: modulating the first RF signal that has been phase-modulated, with the amplitude signal, to generate a second RF signal that has been amplitude-modulated to have an envelope of a gradation including a plurality of stages; and controlling an average value of transmission power of the second RF signal that has been amplitude-modulated to have a predetermined integer number of values. The variable attenuator is capable of changing an attenuation amount by a value that is smaller than a maximum value of a value expressing a difference between adjacent values in decibels, in a case where the predetermined integer number of values are arranged in descending order.

According to the embodiment described above, it is possible to provide a power amplifier, an amplification method, and a transmitter that can achieve high efficiency.

### BRIEF DESCRIPTION OF THE DRAWINGS

FIG. 1 is a conceptual diagram illustrating a transmitter using the EER technique according to a first comparative example.

FIGS. 2A-2D are conceptual diagrams illustrating an amplification method using the SCPA technique according to a second comparative example.

FIG. 3 is a graph illustrating polar modulation using the SCPA technique according to a third comparative example, a horizontal axis indicates time, and a vertical axis indicates, from the top, a square RF carrier signal before modulation, a PM baseband signal (illustrated as a PM signal in the drawing), a phase-modulated RF signal, an AM baseband signal (illustrated as an AM signal in the drawing), an RF output signal, and the product of the AM baseband signal and the PM baseband signal.

FIG. 4 is a graph illustrating polar modulation using the SCPA technique according to the third comparative example, a horizontal axis indicates time, and a vertical axis indicates, from the top, a square RF carrier signal before modulation, a PM baseband signal, a phase-modulated RF signal, an AM baseband signal, an RF output signal, and the product of the AM baseband signal and the PM baseband signal.

FIG. 5 is a block diagram illustrating a transmitter according to the third comparative example.

FIG. 6 is a diagram illustrating a design result in the transmitter according to the third comparative example.

FIG. 7 is a diagram illustrating another design result in the transmitter according to the third comparative example.

FIG. 8 is a graph illustrating an error between the case of 2049 gradations and the case of 1025 gradations in second amplitude control on transmission power performed by a power amplifier core unit in the transmitter according to the third comparative example, a horizontal axis indicates an ideal value of an attenuation amount (ATT), and a vertical axis indicates an error.

FIG. 9 is a block diagram illustrating a power amplifier according to a first embodiment.

FIG. 10 is a diagram illustrating a design result in the power amplifier according to the first embodiment.

FIG. 11 is a diagram illustrating a design result in the power amplifier according to the first embodiment.

FIG. 12 is a flowchart illustrating an amplification method using the power amplifier according to the first embodiment.

FIG. 13 is a block diagram illustrating a transmitter according to a second embodiment.

FIG. 14 is a block diagram illustrating a transmitter according to a first modification of the second embodiment.

FIG. 15 is a block diagram illustrating a transmitter according to a second modification of the second embodiment.

FIG. 16 is a block diagram illustrating a matching circuit in the transmitter according to the second modification of the second embodiment.

FIG. 17 is a block diagram illustrating a configuration of a power amplifier core unit according to a third embodiment.

FIG. 18 is a block diagram illustrating an operation of the power amplifier core unit according to the third embodiment.

FIG. 19 is a block diagram illustrating the power amplifier core unit and a variable attenuator according to the third embodiment.

FIG. 20 is a diagram illustrating a design result in a power amplifier including the power amplifier core unit and the variable attenuator according to the third embodiment.

FIG. 21 is a graph illustrating an average value of transmission power in the power amplifier according to the third embodiment, a horizontal axis indicates time, and a vertical axis indicates transmission power.

### DETAILED DESCRIPTION

For clarity of description, omissions and simplification are made to the description below and the drawings as appropriate. In the drawings, the same elements are denoted by the same reference signs, and a duplicate description is omitted as necessary. Some reference signs are omitted so as not to complicate the drawings in some cases.

First, in <First Comparative Example> to <Third Comparative Example>, power amplifiers, amplification methods, and transmitters according to first to third comparative examples will be described. Thereafter, in <Problems Newly Found by Inventor>, problems that have been newly found by the inventor with regard to the power amplifiers, the amplification methods, and the transmitters according to the first to third comparative examples will be described. In <First Embodiment> to <Third Embodiment>, power amplifiers, amplification methods, and transmitters according to first to third embodiments will be described in comparison with the comparative examples. This will further clarify the power amplifiers, the amplification methods, and the transmitters according to the present embodiments. Note that the first to third comparative examples and the problems newly found by the inventor also fall within the scope of the technical idea of the embodiments.

### First Comparative Example

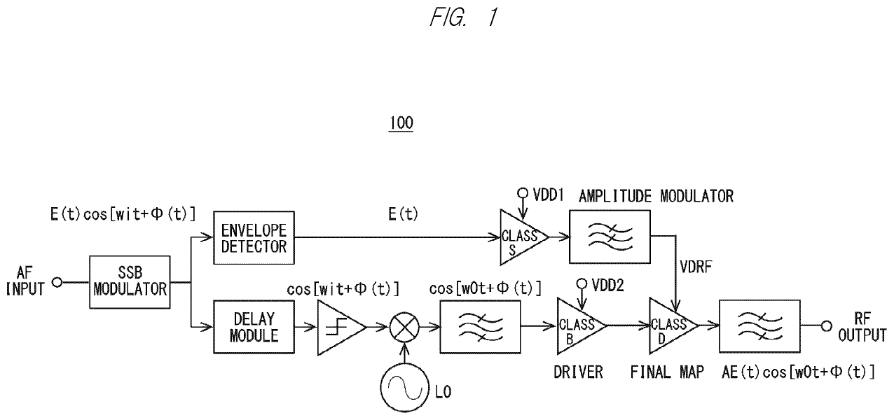

FIG. 1 is a conceptual diagram illustrating a transmitter 100 using the EER technique according to a first comparative example. As illustrated in FIG. 1, the transmitter 100 according to the first comparative example relates to the EER technique described in Non-Patent Document 1. The transmitter 100 according to the first comparative example uses the EER technique or the polar modulation technique. The EER technique or the polar modulation technique is a technique including the following operations (1) to (4) in a radio frequency (RF) transmitter. (1) A baseband signal is temporarily separated into a phase component and an amplitude component. (2) An RF carrier signal is modulated with the phase component of the baseband signal. (3) The RF signal modulated with the phase component is amplified by a power amplifier that controls output amplitude by using the amplitude component of the baseband signal. (4) An RF output signal in which a phase-modulated component and an amplitude-modulated component have been synthesized is obtained again.

Specifically, the transmitter 100 according to the first comparative example temporarily separates an input AF baseband signal into a phase component cos [wit+φ(t)] and an amplitude component E(t). Lower modules illustrated in FIG. 1 modulate an RF carrier signal with the phase component of the baseband signal. The lower modules of the transmitter 100 include, for example, a delay module, a limiter, a frequency converter, a class-B modulator, and the like. Upper modules illustrated in FIG. 1 amplify the RF carrier signal modulated with the phase component, by using a power amplifier that controls output amplitude by using the amplitude component of the baseband signal. The upper modules include an envelope detector, a class-S modulator, and the like.

Then, an RF output signal in which the phase component and the amplitude component have been synthesized is output again. Note that, as in the EER technique described in Non-Patent Document 1, a highly efficient class-D amplifier may be used as the power amplifier. The EER technique can omit a quadrature modulator from the transmitter. In addition, in the EER technique, a highly efficient non-linear amplifier or switching amplifier can be used as a power amplifier that consumes the largest amount of power. Thus, the EER technique can improve power efficiency of the transmitter. As the power amplifier, a power amplifier of a scheme of performing digital control on amplitude can also be used. Amplitude data in this case is input as digital data to the power amplifier. In the first comparative example, output amplitude can be controlled by varying a power supply voltage VDRF of the class-D amplifier. Note that the power supply voltage VDRF has an analog value.

### Second Comparative Example

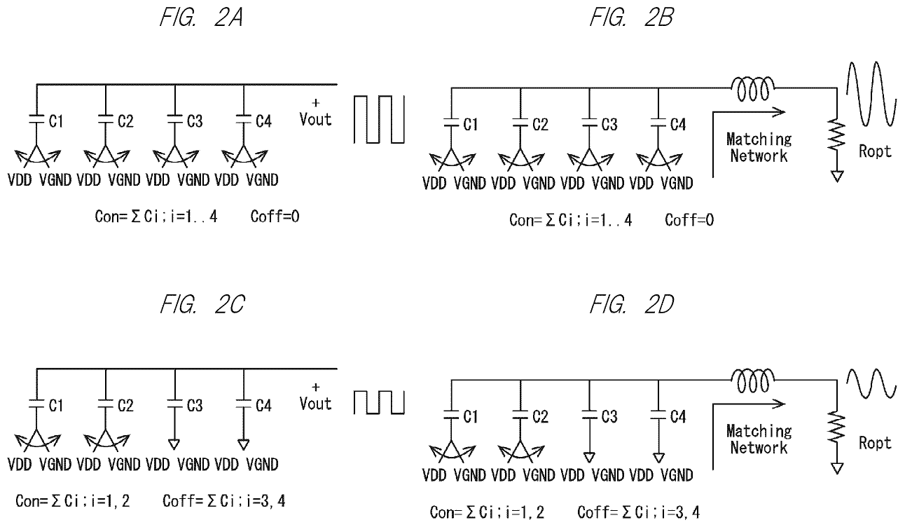

FIGS. 2A-2D are conceptual diagrams illustrating an amplification method using the SCPA technique according to a second comparative example. As illustrated in FIGS. 2A to 2D, the amplification method according to the second comparative example relates to the SCPA technique described in Non-Patent Document 2. The amplification method according to the second comparative example is a technique for digitizing control on output amplitude in the EER technique or the polar modulation technique. In the SCPA technique, an RF carrier signal or a phase-modulated RF carrier signal is applied in a square wave to one end of each of n capacitive elements from among N arranged capacitive elements. Other ends of the remaining (N-n) capacitive elements are fixed to a fixed potential. As a result, the amplitude of the RF carrier signal of 0 to VDD is divided by n/N. By changing a value of n, the output amplitude is accurately controlled.

Specifically, for example, in the case of full power, as illustrated in FIGS. 2A and 2B, the output amplitude is controlled by applying an RF carrier signal or a phase-modulated RF carrier signal in a square wave to all of the N (=4) capacitive elements, that is, by satisfying n=4. On the other hand, in the case of reducing power, as illustrated in FIGS. 2C and 2D, the output amplitude may be controlled, for example, by applying an RF carrier signal or a phase-modulated RF carrier signal in a square wave to two of the N (=4) capacitive elements, that is, by satisfying n=2. Note that a signal for which output amplitude has been controlled may have high output by matching an impedance by using a matching circuit such as a matching network.

### Third Comparative Example

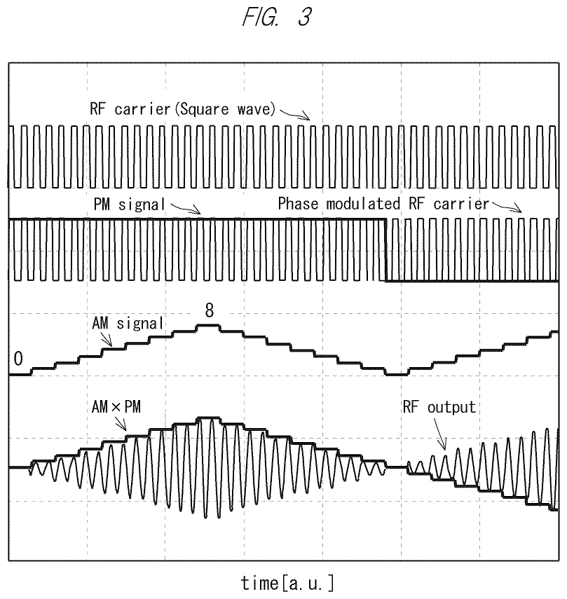

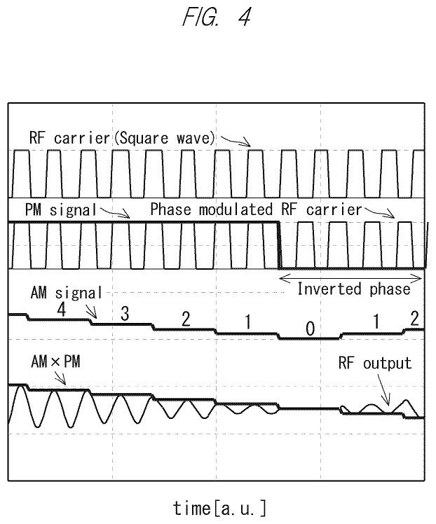

FIGS. 3 and 4 are graphs illustrating polar modulation using the SCPA technique according to a third comparative example, a horizontal axis indicates time, and a vertical axis indicates, from the top, a square RF carrier signal before modulation, a phase signal (referred to as a PM baseband signal, and illustrated as a PM signal in the drawings), a phase-modulated RF carrier signal, an amplitude signal (referred to as an AM baseband signal, and illustrated as an AM signal in the drawings), an RF output signal, and the product of the AM baseband signal and the PM baseband signal. FIG. 4 is an enlarged view illustrating a portion of FIG. 3. In FIGS. 3 and 4, the AM baseband signal is expressed as a numerical value that corresponds to the amplitude of an amplitude control signal provided as a digital signal in the SCPA technique for ease of understanding, and the AM baseband signal does not exist as a real analog signal.

As illustrated in FIGS. 3 and 4, in practice, the amplitude control signal in the SCPA technique (the AM baseband signal) is a digital signal that exists in a digital domain. In the example illustrated in FIG. 3, the AM baseband signal has nine values of 0 to 8. There is also the effect of phase inversion, and therefore this corresponds to modulating the amplitude of an output RF signal to 17 levels in total of −8 to 8. This corresponds to approximately 4 bits as the resolution of modulation. Note that the actually required resolution of modulation depends on a communication standard. Typically, about 4 to 8 bits or more is required for the resolution of modulation.

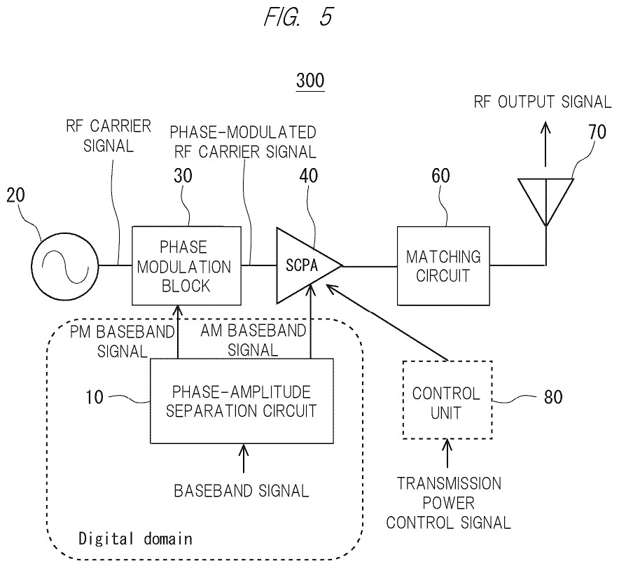

FIG. 5 is a block diagram illustrating a transmitter 300 according to the third comparative example. FIG. 5 illustrates a correspondence relationship with each of the signals described above. As illustrated in FIG. 5, the transmitter 300 includes a phase-amplitude separation circuit 10, a local signal generation circuit 20, a phase modulation block 30, a power amplifier core unit 40, and a matching circuit 60. The transmitter 300 may further include an antenna 70. Also, the transmitter 300 may further include a control unit 80. Note that the transmitter 300 may be configured to be connected to an antenna 70 provided outside. In addition, the control unit 80 may be omitted from the transmitter 300, and the function of the control unit 80 may be performed by software executed on a central processing unit (CPU) mounted on the same chip or another chip.

The phase-amplitude separation circuit 10 separates a baseband signal into a PM baseband signal of a phase component of the baseband signal and an AM baseband signal of an amplitude component of the baseband signal. The phase-amplitude separation circuit 10 outputs the separated PM baseband signal to the phase modulation block 30. The phase-amplitude separation circuit 10 outputs the separated AM baseband signal to the power amplifier core unit 40. The AM baseband signal separated by the phase-amplitude separation circuit 10 is used for the power amplifier core unit 40 to perform amplitude control (referred to as first amplitude control in some cases) on an RF signal to obtain an amplitude-modulated RF output signal.

The local signal generation circuit 20 outputs an RF carrier signal to the phase modulation block 30. The RF carrier signal includes, for example, a plurality of square waveforms.

The phase modulation block 30 modulates the RF carrier signal with the PM baseband signal to generate a phase-modulated RF signal. The phase modulation block 30 outputs the phase-modulated RF signal to the power amplifier core unit 40.

The power amplifier core unit 40 includes, for example, a power amplifier having the SCPA technique. The power amplifier core unit 40 forms an envelope having a plurality of steps illustrated in FIGS. 3 and 4. The power amplifier core unit 40 synthesizes the PM baseband signal and the AM baseband signal again to generate an RF output signal in which a phase-modulated component and an amplitude-modulated component have been synthesized.

The matching circuit 60 generates an RF signal in which an impedance or the like has been matched. An RF output signal generated by the matching circuit 60 is output from the antenna 70.

The control unit 80 performs amplitude control (referred to as second amplitude control in some cases) on an RF output signal to control average transmission power from the antenna 70.

### Problems Newly Found by Inventor

The transmitter 300, such as an RF transmitter, is required to perform second amplitude control to control average transmission power from the antenna 70 in addition to first amplitude control to obtain an RF signal that has been amplitude-modulated with the baseband signal. Here, specific numerical examples will be considered.

For example, in first amplitude control for amplitude modulation, control is performed in such a way that an RF carrier signal has amplitude having 17-level gradation obtained by dividing 0 to 16 at step intervals of 1. When levels of phase inversion are included, in first amplitude control, control is performed to obtain amplitude of gradation having 33 levels obtained by dividing −16 to 16 at step intervals of 1. Amplitude controlled as described above corresponds to modulation accuracy of about 5 bits. A case will be considered where the transmitter 300 having such modulation accuracy performs second amplitude control to control average transmission power of 24 dB at most at step intervals of 1 dB. In order to support both first amplitude control for amplitude modulation and second amplitude control for average transmission power, the number of levels is required to be increased in the gradation of the output amplitude of the power amplifier core unit 40.

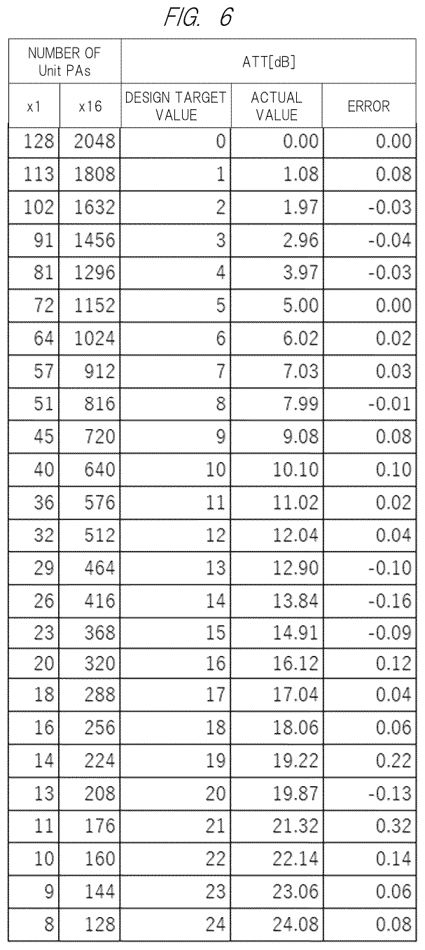

FIG. 6 is a diagram illustrating a design result in the transmitter 300 according to the third comparative example. As illustrated in FIG. 6, amplitude control performed by the power amplifier core unit 40 in the transmitter 300 has gradation having 2049 levels of 0 to 2048. Here, gradation having 2049 levels is simply referred to as 2049 gradations in some cases.

In the case of a maximum output, that is, in a case where an attenuation amount is 0 dB, the amplitude of an RF carrier signal is controlled to have 17 gradations obtained by dividing 0 to 2048 at step intervals of 128 with 128 codes in a signal of first amplitude control as one unit (×1). Stated another way, the amplitude of the RF carrier signal is controlled to have 17 gradations, 0/128/256/384/ . . . /2048. As a result, the envelope of the RF carrier signal is reproduced. Here, in some cases, the attenuation amount is referred to as an ATT or an ATT amount by taking three letters from the attenuation amount or an attenuator. For example, the ATT may be used when used to indicate a quantity. The ATT amount may be used when used to mean the attenuation amount.

In the case of an ATT of 24 dB, the amplitude of the RF carrier signal is controlled to have 17 gradations obtained by dividing 0 to 128 at step intervals of 8 with 8 codes in a signal of first amplitude control as one unit (×1). As a result, the envelope of the RF carrier signal is reproduced. A ratio of the amplitude of transmission power between this and the time of a maximum output is 8/128. In terms of dB,20 log(8/128 )=−24.08 dB. An absolute value of an error relative to a design target of 24 dB is 0.08 dB. With respect to respective ATTs of 0 to 24 dB, a maximum value of an absolute value of an error is 0.32 dB when ATT=21 dB.

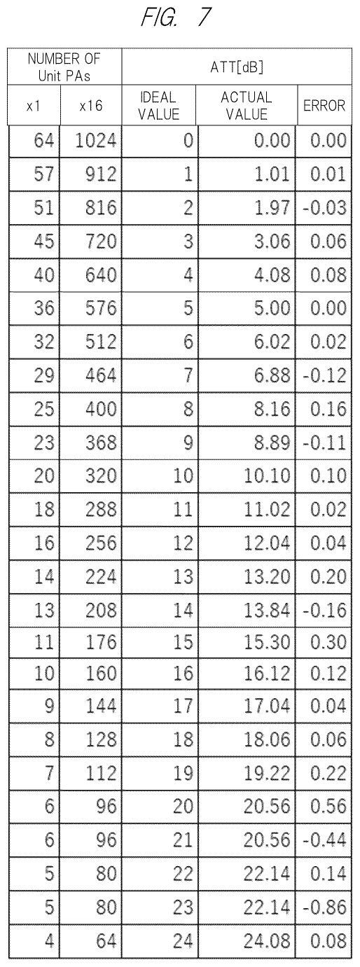

FIG. 7 is a diagram illustrating another design result in the transmitter 300 according to the third comparative example. FIG. 7 illustrates an example where the power amplifier core unit 40 has performed amplitude control to have 1025 gradations of 0 to 1024, which are about half compared to 2049 gradations. As illustrated in FIG. 7, in this case, the resolution of the output amplitude of transmission power at the time of a low output is insufficient. Therefore, for example, in cases where ATT=24 dB, 23 dB, 22 dB, and 21 dB, units of an amplitude control code are 4, 5, 5, and 6, respectively. Thus, the output amplitude in a case where ATT=22 dB needs to be the same as the output amplitude in a case where ATT=23 dB.

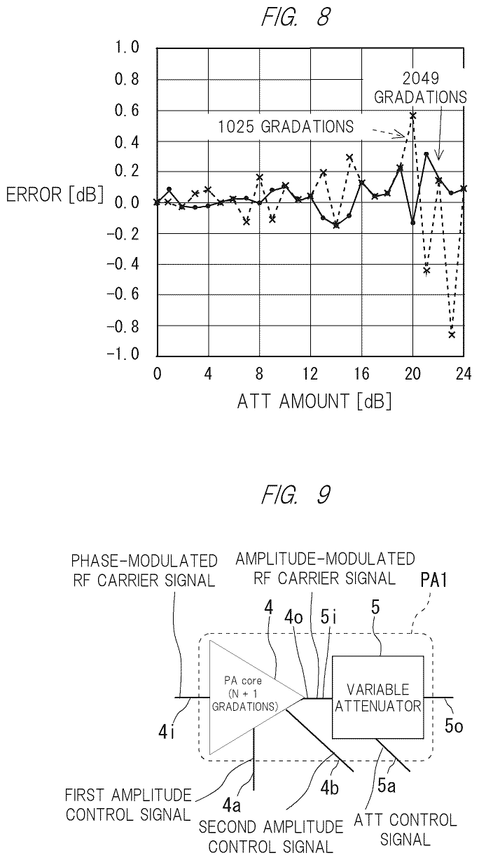

FIG. 8 is a graph illustrating an error in average transmission power control between the case of 2049 gradations and the case of 1025 gradations in amplitude control performed by the power amplifier core unit 40 in the transmitter 300 according to the third comparative example, a horizontal axis indicates an ideal value of the ATT, and a vertical axis indicates an error. As illustrated in FIG. 8, in both the case of 2049 gradations and the case of 1025 gradations, an absolute value of the error tends to increase in a region where the ATT amount is large. In addition, the error is larger in the case of 1025 gradations in which the resolution of output amplitude is low. As described above, in general, when an attempt is made to perform second amplitude control for accurate average transmission power in a region where the ATT amount is large, the resolution of necessary output amplitude deteriorates.

However, in practice, it is difficult to design a power amplifier including the power amplifier core unit 40 that is capable of controlling output amplitude to have 2049 gradations, as illustrated in FIG. 6. First, division of the power amplifier core unit 40 into a large number of unit PAs leads to an increase in a dead space of the layout. For example, the power amplifier core unit 40 capable of controlling the output amplitude to have 2049 gradations requires 2048 unit PAs.

Furthermore, division of the power amplifier core unit 40 into a large number of unit PAs causes an increase in an amount of wiring of an RF carrier signal to be distributed to each of the unit PAs or an on/off control signal of the unit PA. This results in a further increase in the dead space. As a result, in such a power amplifier, a signal line becomes long and complicated, and an error in signal timing increases. Therefore, the accuracy of modulation deteriorates. In addition, parasitic capacitance and parasitic inductance of the wiring also increase, and this leads to an increase in a power loss.

As another implementation method for solving the problem of the dead space and the amount of wiring, it is conceivable to binary-weight the size of the unit PA into 1, 2, 4, . . . . However, in this case, it is difficult to maintain the performance of a unit PA that corresponds to ×1 in a proportional relationship with a unit PA that corresponds to the maximum ×1024 gradation. In addition, in reproducing a modulated signal, the frequency of on/off in each of the unit PAs increases, and it becomes difficult to generate a low distortion waveform. For example, in the configuration described above in which a large number of unit PAs of ×1 are arranged, it is sufficient if one unit PA at a time is sequentially brought into the on state. In contrast, in a case where the amplitude is linearly increased to 0, 1, 2, 3, 4, . . . , in a configuration that employs the binary, a unit PA of ×1 repeats the on/off state in such a way that off, on, off, on, off, on. A unit PA of ×2 repeats the on/off state in such a way that off, off, on, on, off, off, on, on. Therefore, the frequency of on/off increases.

As described above, in the transmitter 300 using the EER technique or the polar modulation technique for controlling amplitude by using a digital signal, the number of gradations in first amplitude control and second amplitude control performed by the power amplifier core unit 40 is limited. Therefore, it is difficult to secure both a broad output variable range and the accuracy of modulation.

### First Embodiment

Next, a power amplifier according to a first embodiment will be described. FIG. 9 is a block diagram illustrating a power amplifier PA1 according to the first embodiment. As illustrated in FIG. 9, the power amplifier PA1 according to the present embodiment includes a power amplifier core unit 4 and a variable attenuator 5.

The power amplifier core unit 4 is configured to be able to perform amplitude control in discrete integer steps. For example, the power amplifier core unit 4 is configured to be able to perform discrete amplitude control in (N+1) steps, 0 to N. The power amplifier core unit 4 performs amplitude control to reproduce an envelope of an RF signal. The variable attenuator 5 changes an ATT amount. Therefore, the power amplifier PA1 according to the present embodiment controls average transmission power by using a combination of amplitude control performed by the power amplifier core unit 4 and an ATT amount of the variable attenuator 5.

The power amplifier core unit 4 includes an input terminal 4i, a first terminal 4a, a second terminal 4b, and an output terminal 4o. The input terminal 4i is a terminal to which a phase-modulated RF carrier signal is input. The first terminal 4a is a terminal to which a first amplitude control signal is input. The second terminal 4b is a terminal to which a second amplitude control signal is input. The output terminal 4o is a terminal from which an RF signal that has been amplitude-modulated by the power amplifier core unit 4 is output to the variable attenuator 5.

The variable attenuator 5 includes an input terminal 5i, a first terminal 5a, and an output terminal 5o. The input terminal 5i is a terminal to which an amplitude-modulated RF signal is input. The first terminal 5a is a terminal to which an ATT control signal is input. The output terminal 5o is a terminal from which an RF signal to which a predetermined ATT amount has been applied by the variable attenuator 5 is output.

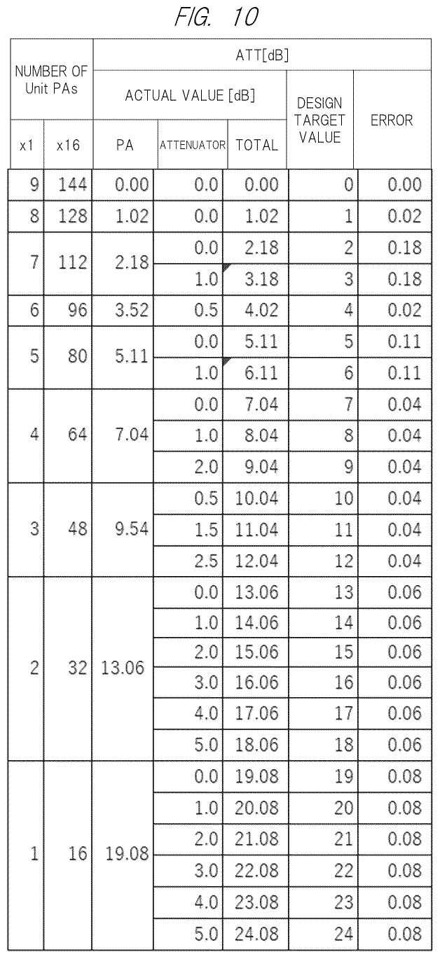

FIG. 10 is a diagram illustrating a design result in the power amplifier PA1 according to the first embodiment. As illustrated in FIG. 10, the power amplifier PA1 according to the present embodiment can achieve second amplitude control to control average transmission power in 145 gradations, 0 to 144. Specifically, the power amplifier PA1 according to the present embodiment controls the amplitude of an RF carrier signal to obtain output amplitude of 17 gradations obtained by dividing 0 to 16 at step intervals of 1. In addition, average transmission power is controlled within a range of 24 dB obtained by division at step intervals of 1 dB by using a combination of amplitude control performed by the power amplifier core unit 4 and an attenuation amount of the variable attenuator 5. Amplitude that corresponds to each level controlled in first amplitude control may be set at equal intervals or partially at unequal intervals with respect to a control code. In addition, the entire portion may be set completely at unequal intervals. Amplitude that corresponds to each level controlled in second amplitude control may be set at equal intervals or partially at unequal intervals with respect to the control code. In addition, the entire portion may be set completely at unequal intervals.

In order to control transmission power within a range of 24 dB divided at step intervals of 1 dB similarly to the power amplifier PA1 according to the present embodiment, the power amplifier according to the third comparative example described above requires second amplitude control performed by a power amplifier of 2049 gradations, as illustrated in FIG. 6. A design example according to the present embodiment will be described in more detail below.

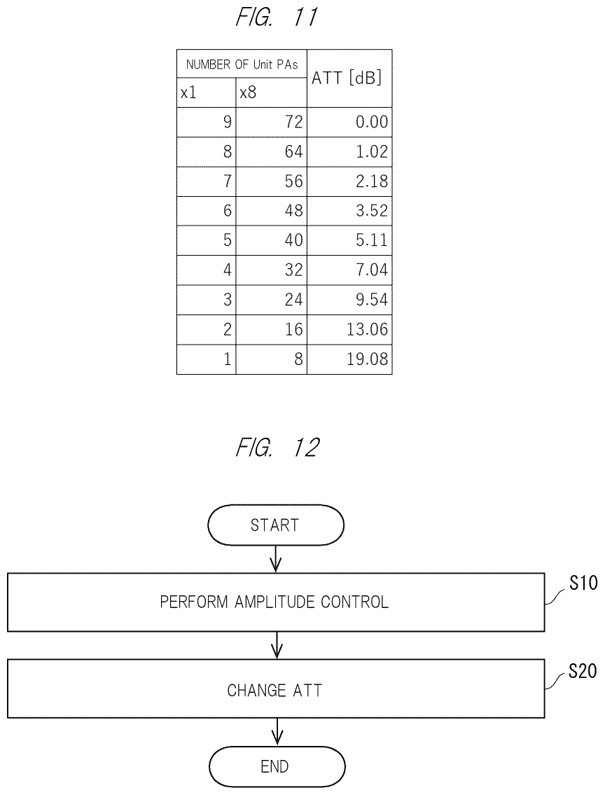

FIG. 11 is a diagram illustrating a design result in the power amplifier PA1 according to the first embodiment. As illustrated in FIG. 11, the power amplifier core unit 4 can perform control in nine levels, from an operation of 17 gradations, 0 to 16, with “×1” as output amplitude 1 to an operation in 17 gradations, 0 to 144, with “×9” as output amplitude 9. An ATT amount in a case where the variable attenuator 5 does not operate has nine levels in such a way that ATT=0 dB, 1.0 dB, 2.2 dB, 3.5 dB, 5.1 dB, 7.0 dB, 9.5 dB, 13.1 dB, and 19.1 dB. As illustrated in FIG. 10, the variable attenuator 5 combines this with an ATT amount of 6.0 dB at most at step intervals of 0.5 dB. As a result, the power amplifier PA1 can achieve an ATT amount of 24 dB at most with a maximum error of 0.18 dB.

In such a configuration of the power amplifier PA1 according to the present embodiment, the number of gradations in the control of output amplitude by the power amplifier core unit 4 can be reduced in comparison with the third comparative example. Therefore, the layout becomes compact, and the control wiring becomes simple. Thus, the power amplifier PA1 according to the present embodiment makes it possible to realize a small and highly efficient transmitter. As described above, the power amplifier PA1 according to the present embodiment achieves high-range and high-accuracy output power control by using a power amplifier having a small number of gradations in amplitude control, and this achieves a reduction in size and an operation with high power efficiency of a transmitter.

On the other hand, in a case where an ATT amount of the variable attenuator 5 is large, there is a possibility of a decrease in the efficiency of a transmitter due to dissipation of power of an RF carrier signal. If the power dissipation is large, lower power consumption of the entirety of the transmitter cannot be achieved. However, this is not a problem in practice for the reason described below.

First, a range where ATT=8 dB or less and transmission power is large is considered. As illustrated in FIG. 10, in a case where set target value ATT=0 dB, 1 dB, 2 dB, 5 dB, and 7 dB, the variable attenuator 5 has been set to 0 dB. Therefore, no problem of dissipation of the power of an RF carrier signal occurs. In another case where set target value ATT=3 dB, 4 dB, 6 dB, and 8 dB, the ATT of the variable attenuator 5 has been set to be small, 0.5 to 1.0 dB. The power dissipated as a result of this is 10% or 20% of each transmission power. Assuming that the efficiency of a power amplifier in a case where target set value ATT=0 dB is 50%, dissipated power is only 5% (=10%×50%) or 10% (=20%×50%) of power consumption. This does not exceed improvements in efficiency of the single power amplifier core unit 4 according to the present embodiment.

When the ATT amount of the variable attenuator 5 is large, a ratio of power dissipation of an RF carrier signal increases. As illustrated in FIG. 10, in a region where ATT=16 dB or more, the variable attenuator 5 is controlled to have an ATT of 3 dB or more, and stated another way, 50% or more of the power of the RF carrier signal is dissipated. However, in this region, an absolute value of transmission power of the RF carrier signal is small, and therefore an absolute value of transmission power dissipated due to the variable attenuator 5 is also small. To give a specific numerical value, when ATT=16 dB, the transmission power of the power amplifier core unit 4 is lower by 13 dB than transmission power at a time when ATT=0 dB. Stated another way, the transmission power is reduced to 1/20. The variable attenuator 5 has been set to 3 dB, and therefore dissipated RF power is only half of the transmission power.

In general, the efficiency of a power amplifier is the highest near the time of a maximum output, and the efficiency decreases in such a region of low transmission power. Stated another way, in a case where ATT=16 dB, the efficiency of the power amplifier core unit also decreases, and the self-consumed power of the single power amplifier core unit 4 is larger than power dissipated due to the variable attenuator 5. Stated another way, the power dissipated due to the variable attenuator 5 becomes even more negligible in relative terms.

As described above, according to the present embodiment, the layout of the power amplifier core unit 4 becomes compact, and the amount of control wiring is also reduced to 1/10 or less from control in 2049 gradations according to the third comparative example to control in 145 gradations illustrated in FIG. 11. This has a significant effect of reducing the self-consumed transmission power of the power amplifier PA1 according to the present embodiment. Therefore, the power amplifier PA1 according to the present embodiment can reduce power consumption in the entirety of the transmitter.

FIG. 12 is a flowchart illustrating an amplification method using the power amplifier PA1 according to the first embodiment. As illustrated in FIG. 12, the amplification method according to the present embodiment includes step S10 of performing amplitude control, and step S20 of changing an ATT amount.

In step S10, the power amplifier core unit 4 performs amplitude control in discrete integer steps. The power amplifier core unit 4 performs amplitude control to reproduce an envelope of an RF carrier signal. In step S20, the variable attenuator 5 changes an ATT amount. As a result, the power amplifier PA1 controls average transmission power by using a combination of amplitude control performed by the power amplifier core unit 4 and the ATT amount of the variable attenuator 5.

### Second Embodiment

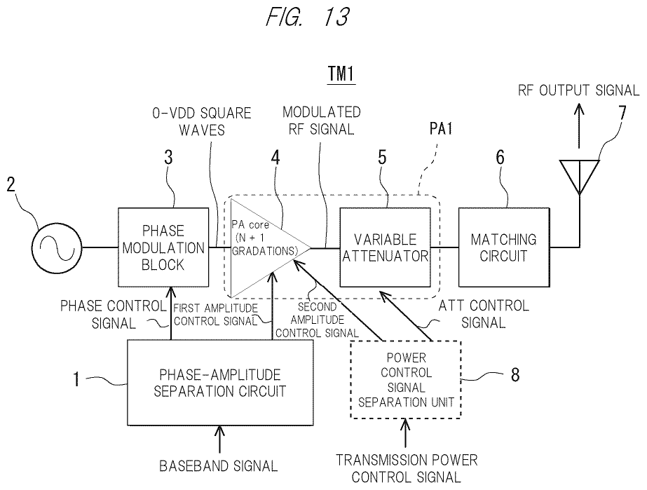

Next, a transmitter according to a second embodiment will be described. FIG. 13 is a block diagram illustrating a transmitter TM1 according to the second embodiment. As illustrated in FIG. 13, the transmitter TM1 according to the present embodiment includes a phase-amplitude separation circuit 1, a local signal generation circuit 2, a phase modulation block 3, and a matching circuit 6 in addition to the power amplifier core unit 4 and the variable attenuator 5. The transmitter TM1 may further include an antenna 7. Also, the transmitter TM1 may further include a power control signal separation unit 8. Note that the transmitter TM1 may be configured to be connected to an antenna 7 provided outside. In addition, the power control signal separation unit 8 may be omitted from the transmitter TM1, and the function of the power control signal separation unit 8 may be assigned to software executed on a CPU mounted on the same chip or another chip.

The phase-amplitude separation circuit 1 separates a baseband signal into a PM baseband signal of a phase component of the baseband signal and an AM baseband signal of an amplitude component of the baseband signal. In the present embodiment, the PM baseband signal is referred to as a phase control signal. In addition, the AM baseband signal is referred to as a first amplitude control signal. The phase-amplitude separation circuit 1 outputs the separated phase control signal to the phase modulation block 3. The phase-amplitude separation circuit 1 outputs the separated first amplitude control signal to the power amplifier core unit 4 via the first terminal 4a. The first amplitude control signal is used for the power amplifier core unit 4 to perform first amplitude control on an RF signal to obtain an amplitude-modulated RF signal.

The local signal generation circuit 2, the phase modulation block 3, and the matching circuit 6 have functions similar to those of the local signal generation circuit 20, the phase modulation block 30, and the matching circuit 60 according to the third comparative example. In the present embodiment, the variable attenuator 5 is disposed between the power amplifier core unit 4 and the matching circuit 6.

The power control signal separation unit 8 is connected to the second terminal 4b of the power amplifier core unit 4 and the first terminal 5a of the variable attenuator 5. The power control signal separation unit 8 receives a transmission power control signal. The power control signal separation unit 8 separates the transmission power control signal into a second amplitude control signal and an ATT control signal. The power control signal separation unit 8 outputs the separated second amplitude control signal to the power amplifier core unit 4 via the second terminal 4b. The second amplitude control signal is used for the power amplifier core unit 4 to perform second amplitude control to control average transmission power to be output from the antenna 7. The power control signal separation unit 8 outputs the separated ATT control signal to the variable attenuator 5 via the first terminal 5a. The ATT control signal is used in the variable attenuator 5 to control the change in the ATT amount.

The transmitter TM1 according to the present embodiment uses the power amplifier PA1 that is capable of controlling the amplitude of an RF signal in a small number of gradations, and thus high-range and high-accuracy output power control is achieved. As a result, the transmitter TM1 achieves a reduction in size and a high power-efficiency operation. As a specific example, in a case where the same specifications as the specifications of the transmitter 300 of the third comparative example are employed, that is, in a case where average transmission power is controlled within a range of 24 dB at step intervals of 1 dB, the number of gradations can be smaller than that of the transmitter 300 according to the third comparative example. Stated another way, the transmitter TM1 can achieve output amplitude of an RF output signal in 17 gradations, 0 to 16, obtained as a result of division at step intervals of 1.

### First Modification

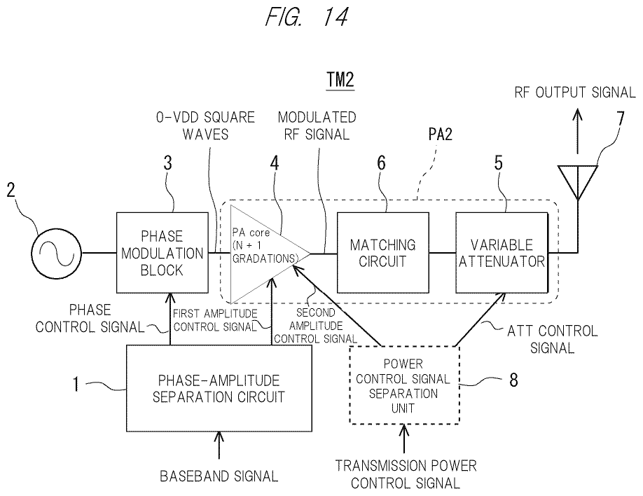

FIG. 14 is a block diagram illustrating a transmitter TM2 according to a first modification of the second embodiment. As illustrated in FIG. 14, in the transmitter TM2 according to the present modification, the power amplifier core unit 4, the matching circuit 6, the variable attenuator 5, and the antenna 7 are connected in this order. In comparison with the configuration of the transmitter TM1 according to the second embodiment described above, the positions of the variable attenuator 5 and the matching circuit 6 are changed. An RF carrier signal output from the output terminal 4o of the power amplifier core unit 4 is input to the matching circuit 6. Then, the RF signal output from the matching circuit 6 is input to the variable attenuator 5. The transmitter TM2 according to the present modification includes a power amplifier PA2. The power amplifier PA2 includes the matching circuit 6 between the power amplifier core unit 4 and the variable attenuator 5. Such a configuration can also achieve effects that are similar to those of the second embodiment.

### Second Modification

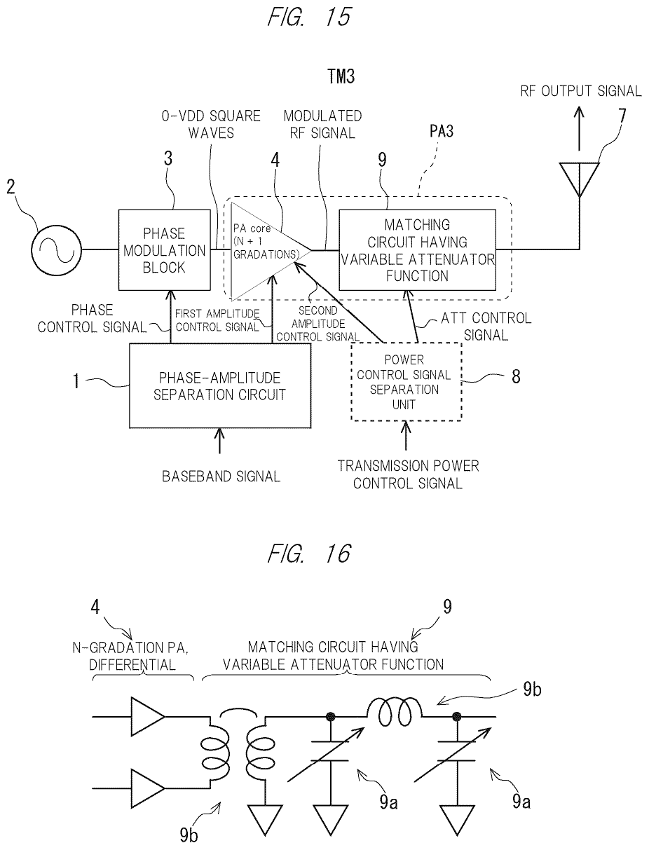

FIG. 15 is a block diagram illustrating a transmitter TM3 according to a second modification of the second embodiment. As illustrated in FIG. 15, the transmitter TM3 according to the present modification includes a matching circuit 9 in which the variable attenuator 5 and the matching circuit 6 have been integrally designed, instead of the variable attenuator 5 and the matching circuit 6. Therefore, a power amplifier PA3 of the transmitter TM3 includes the power amplifier core unit 4 and the matching circuit 9. The matching circuit 9 that matches an output impedance has a function of a variable attenuator. In other words, a variable attenuator according to the present modification includes the matching circuit 9 having the function of the attenuator, and includes the matching circuit 9 that matches the output impedance. The matching circuit 9 is connected to the output terminal 4o of the power amplifier core unit 4. The matching circuit 9 receives an ATT control signal from the power control signal separation unit 8.

FIG. 16 is a block diagram illustrating the matching circuit 9 in the transmitter TM3 according to the second modification of the second embodiment. As illustrated in FIG. 16, the matching circuit 9 according to the present modification includes two variable capacitors 9a. Each of the variable capacitors 9a includes a capacitive element and a switch. The variable capacitor 9a can control a capacitive value between two terminals of the capacitive element with a digital code. One end of each of the variable capacitors 9a is connected to the power amplifier core unit 4. Another end of each of the variable capacitors 9a is connected to a fixed potential such as ground. A coil 9b may be appropriately disposed between the variable capacitors 9a and between the variable capacitor 9a and the power amplifier core unit 4.

In general, as a means to tune a difference between characteristics at the time of design and actual characteristics, the matching circuit 9 including the variable capacitor 9a, as illustrated in FIG. 16, is often used. The function of the variable capacitor 9a is also used as a means to achieve a variable attenuator in controlling transmission power according to the present modification. The variable capacitor 9a according to the present modification may be originally provided as a means to absorb a design error. This makes it unnecessary to newly add the variable attenuator 5.

### Third Embodiment

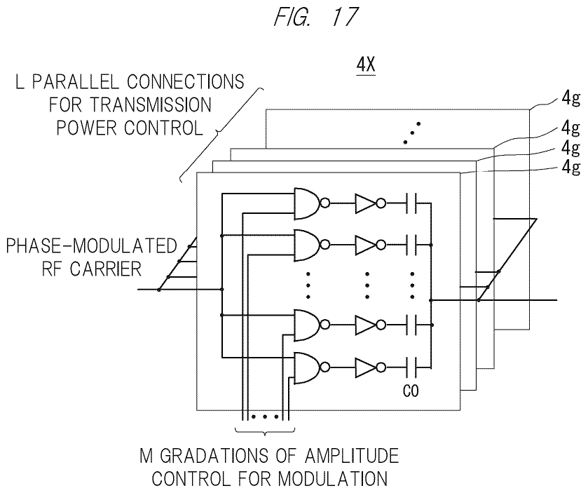

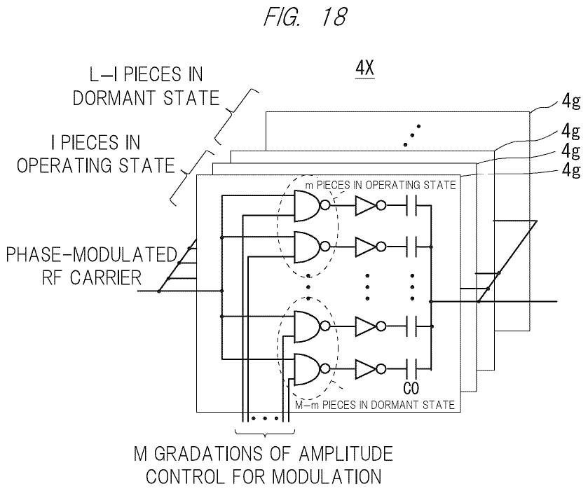

Next, a power amplifier core unit according to a third embodiment will be described. FIG. 17 is a block diagram illustrating a configuration of a power amplifier core unit 4X according to the third embodiment. FIG. 18 is a block diagram illustrating an operation of the power amplifier core unit 4X according to the third embodiment. As illustrated in FIGS. 17 and 18, the power amplifier core unit 4X includes a plurality of unit power amplifier groups 4g. The power amplifier core unit 4X includes, for example, L unit power amplifier groups 4g. The plurality of unit power amplifier groups 4g is connected in parallel to each other.

The unit power amplifier group 4g includes a plurality of capacitors, and a logic circuit that switches the capacitors to an operating state or a dormant state. Each of the unit power amplifier groups 4g can perform amplitude control so as to have gradation of a plurality of levels. Each of the unit power amplifier groups 4g can perform control to have amplitude in (M+1) gradations, for example, 0 to M. As a result, the power amplifier core unit 4X has a configuration in which L unit power amplifier groups 4g that are capable of performing amplitude control in (M+1) gradations including an output of zero are connected in parallel. Stated another way, L×M (the product of L and M) is a value that corresponds to N in N+1 gradations, from 0 to N, for amplitude control by the power amplifier core unit 4X. Here, L, M, and N are integers. Each of the unit power amplifier groups 4g may include a switched-capacitor PA (SCPA) including M unit amplifiers. As described above, the power amplifier core unit 4X may include the switched-capacitor power amplifier.

As illustrated in FIG. 18, control on the average transmission power of an RF signal is achieved by using a combination of l (a small letter of L) unit power amplifier groups 4g to be activated from among the L unit power amplifier groups 4g and control on an ATT performed by the variable attenuator 5. The remaining (L−l) unit power amplifier groups 4g are always in a dormant state and are in an off state of transmitting an RF carrier signal. As described above, the power amplifier according to the present embodiment controls average transmission power by using a combination of control on the number of operating unit power amplifier groups 4g from among the L unit power amplifier groups 4g connected in parallel and an ATT amount of the variable attenuator 5.

Each of the unit power amplifier groups 4g can perform amplitude control in (M+1) gradations. Focusing on each of the active l unit power amplifier groups 4g, m unit amplifiers are instantaneously active, and (M−m) unit amplifiers are in a dormant state. By controlling a value of m with time, the power amplifier core unit 4X can perform control in (M+1) gradations to reproduce the envelope of an RF carrier signal. The l unit power amplifier groups 4g perform the same operation.

In the configuration of the power amplifier core unit 4X according to the present embodiment, the first amplitude control signal to reproduce the envelope of the RF carrier signal and the second amplitude control signal to control average transmission power are separated. Therefore, a decoder that performs gradation control in the power amplifier core unit 4X can be simplified. Depending on a radio scheme, the band of a baseband signal ranges from about 100 MHz to about several hundreds MHz. In this case, the permissible timing error for the first and second amplitude control signals is required to be equal to or less than 1/(signal bandwidth), i.e., 10 ns or less. Simplification of the decoder is advantageous for reducing the timing error and improving the accuracy of modulation of an envelope component of the RF carrier signal. In addition, all of the unit power amplifier groups 4g can have the same design. As the design in that case, it is sufficient to design one unit power amplifier group 4g and then arrange L such groups. Therefore, the power amplifier core unit 4X can be easily designed.

Note that a change in amplitude of the RF carrier signal that corresponds to each gradation of control in (N+1) gradations and (M+1) gradations may be set at equal intervals, partially at unequal intervals, or completely at unequal intervals. This is a design matter. In addition, the sizes of the L unit power amplifier groups 4g connected in parallel may be all equal, may be binary-weighted, or may be arbitrarily set at unequal intervals. This is a design matter. Furthermore, the unit power amplifier group 4g may be an SCPA as described in the present embodiment, may be another switching amplifier, or may have another configuration. This is a design matter.

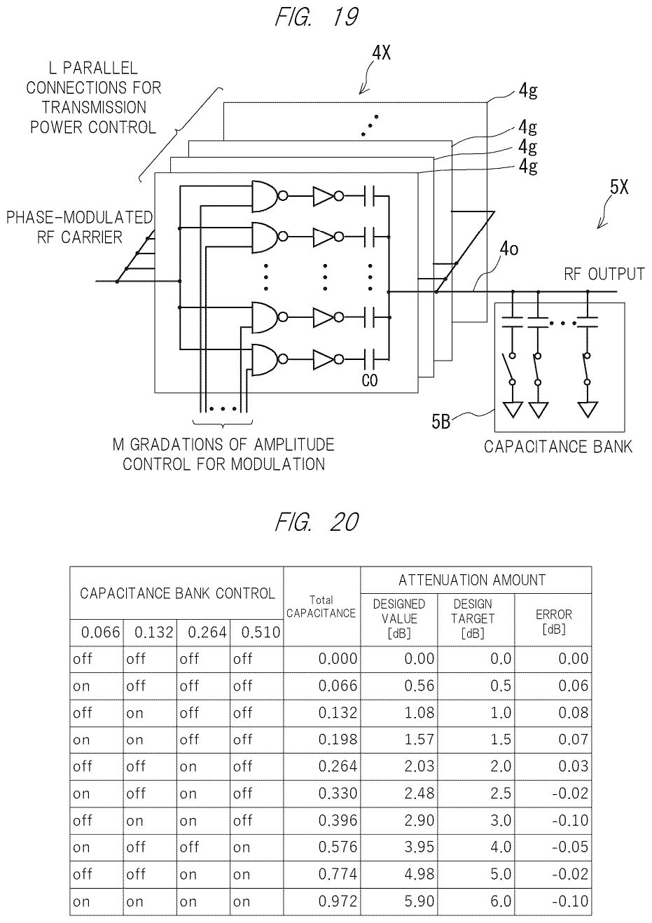

FIG. 19 is a block diagram illustrating the power amplifier core unit 4X and a variable attenuator 5X according to the third embodiment. As illustrated in FIG. 19, the variable attenuator 5X is connected to the output terminal 4o of the power amplifier core unit 4X. The variable attenuator 5X may include a capacitance bank 5B. One end of the capacitance bank 5B is connected to the output terminal 4o of the power amplifier core unit 4X. Another end of the capacitance bank 5B is connected to a fixed potential node such as ground. As described above, the variable attenuator 5X may include the capacitance bank 5B having one end connected to a signal line through which the RF carrier signal passes and another end connected to a fixed potential line.

A capacitance value of one unit of the SCPA in the power amplifier core unit 4X is assumed to be C0. The total capacitance of the SCPA in the power amplifier core unit 4X is L×M ×C0. When it is assumed that the number of parallels to be activated of the SCPA is 1, an instantaneous value of an amplitude control signal for modulation is m, and the capacitance of the capacitance bank 5B is Cbank, the output amplitude of the RF output signal is proportional to Formula (1) described below.

1×M×C0/(l×M×C0+Cbank) (1)

Stated another way, Cbank serving as a variable capacitor substantially functions as a variable attenuator. When Formula (1) is converted into dB, Formula (2) described below is obtained.

20 log{1×m×C0/(L×M×C0+Cbank)}

=20 log(m/M)+20 log(l/L)−20 log{1+Cbank/(L×M×C0)} (2)

A first term in a right-hand side is a term relating to reproduction of the envelope of the RF carrier signal. A second term in the right-hand side indicates a control value of average transmission power of an RF carrier signal with regard to the number l of unit power amplifier groups 4g in an active state. A third term indicates a control value of the transmission power of an RF signal with respect to the capacitance Cbank of the capacitance bank 5B that substantially functions as the variable attenuator 5X.

FIG. 20 is a diagram illustrating a design result in a power amplifier including the power amplifier core unit 4X and the variable attenuator 5X according to the third embodiment. As illustrated in FIG. 20, the capacitance Cbank of the capacitance bank 5B is controlled by 4 bits. It is assumed that capacitances at which respective bits are turned on/off are 0.066×L×M×C0, 0.132×L×M×C0, 0.264×L×M×C0, and 0.510×L×M×C0. A truth table of the capacitance bank 5B is as illustrated in FIG. 20. In this case, an ATT amount (an attenuation amount) changes at each step of 0.5 dB from 0 dB to 3.0 dB. The ATT amount changes at each step of 1.0 dB from 3 dB to 6.0 dB. As described above, the variable attenuator 5X according to the present embodiment can achieve amplitude control with a maximum error of 0.1 dB in the ATT of 0 dB to 6.0 dB.

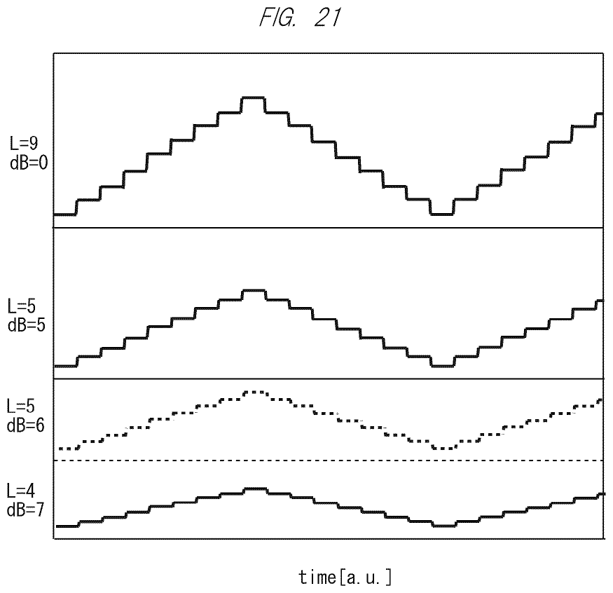

FIG. 21 is a graph illustrating an average value of transmission power in the power amplifier according to the third embodiment, a horizontal axis indicates time, and a vertical axis indicates transmission power. In FIG. 21, a phase inverted portion is omitted. As illustrated in FIG. 21, the power amplifier core unit 4X modulates a phase-modulated RF carrier signal with an amplitude signal to generate an RF output signal that has been amplitude-modulated to have an envelope of gradation including a plurality of levels.

For example, in the power amplifier core unit 4X, in a case where L and M are integers, L unit power amplifier groups 4g that are capable of performing control in (M+1) gradations may be connected in parallel. The power amplifier core unit 4X may generate an envelope of (M+1) gradations.

In addition, the power amplifier core unit 4X may perform control in such a way that average values of transmission power of the RF output signal have L values. In FIG. 21, the amplitudes of transmission power in cases where L=9, L=5, and L=4 are indicated with solid lines. The transmission power in a case where L=9 corresponds to ATT=0 dB. The transmission power in a case where L=5 corresponds to ATT=5 dB. The average transmission power in a case where L=4 corresponds to ATT=7 dB. However, control by the power amplifier core unit 4 alone cannot make the transmission power correspond to ATT=6 dB. Stated another way, control by the power amplifier core unit 4 alone cannot make the transmission power correspond to an ATT between the case of L=5 and the case of L=4.

Therefore, in a case where an integer number of average values of transmission power are arranged in descending order, the variable attenuator 5X can change an attenuation amount by a value that is smaller than a maximum value of a value expressing a difference between adjacent values in decibels. For example, in a case where an integer number L of values are arranged in descending order, the variable attenuator 5X may attenuate transmission power in such a way that the average value of the transmission power falls between at least one pair of the arranged values. Specifically, as illustrated with a dotted line in FIG. 21, the variable attenuator 5X attenuates transmission power so as to achieve dB=6, which is between dB=7 at L=4 and dB=5 at L=5. In this manner, the power amplifier core unit 4X and the variable attenuator 5X can perform highly accurate amplitude control while minimizing the number of unit power amplifier groups 4g. Therefore, the power amplifier and the transmitter TM3 can be reduced in size, and can be increased in efficiency.

The invention made by the present inventor has been specifically described above on the basis of the embodiments. However, it goes without saying that the present invention is not limited to the embodiments described above, and various modifications can be made within the range not departing from the gist of the present invention. For example, appropriate combinations of respective configurations of the first to third comparative examples, the first to third embodiments, and the modifications are also within the range of the technical idea of the embodiments.

What is claimed is:

1. A power amplifier comprising:
a power amplifier core unit that is capable of performing amplitude control in discrete integer steps; and
a variable attenuator.

2. The power amplifier according to claim 1,
wherein the power amplifier core unit performs the amplitude control to reproduce an envelope of an RF signal,
wherein the variable attenuator changes an attenuation amount, and
wherein average transmission power is controlled by using a combination of the amplitude control performed by the power amplifier core unit and the attenuation amount of the variable attenuator.

3. The power amplifier according to claim 1,
wherein the power amplifier core unit includes a switched capacitor power amplifier, and
wherein the variable attenuator includes a capacitance bank having one end connected to a signal line through which an RF signal output from the power amplifier core unit passes and another end connected to a fixed potential line.

4. The power amplifier according to claim 1,
wherein, in a case where L and M are integers,
in the power amplifier core unit, L unit amplifier groups are connected in parallel, the L unit amplifier groups being capable of performing control in (M+1) gradations including an output of zero.

5. The power amplifier according to claim 4,
wherein the power amplifier core unit performs control in the (M+1) gradations to reproduce an envelope of an RF signal, and
wherein average transmission power is controlled by using a combination of control on a number of unit amplifier groups to operate from among the L unit amplifier groups that are connected in parallel and an attenuation amount of the variable attenuator.

6. The power amplifier according to claim 1, wherein a change in amplitude of an RF signal that corresponds to each gradation includes a portion that is not set at equal intervals.

7. The power amplifier according to claim 4, wherein a change in amplitude of an RF signal that corresponds to each gradation in control in the (M+1) gradations includes a portion that is not set at equal intervals.

8. The power amplifier according to claim 1, wherein the variable attenuator includes a matching circuit that has a function of an attenuator and matches an output impedance.

9. An amplification method comprising:
a step of performing amplitude control in discrete integer steps by using a power amplifier core unit; and
a step of changing an attenuation amount by using a variable attenuator.

10. The amplification method according to claim 9,
wherein, in the step of performing the amplitude control,
the power amplifier core unit performs the amplitude control to reproduce an envelope of an RF signal, and
average transmission power is controlled by using a combination of the amplitude control performed by the power amplifier core unit and the attenuation amount of the variable attenuator.

11. The amplification method according to claim 9,
wherein the power amplifier core unit includes a switched capacitor power amplifier, and
wherein the variable attenuator includes a capacitance bank having one end connected to a signal line through which an RF signal output from the power amplifier core unit passes and another end connected to a fixed potential line.

12. The amplification method according to claim 9,
wherein, in a case where L and M are integers,
in the power amplifier core unit, L unit amplifier groups are connected in parallel, the L unit amplifier groups being capable of performing control in (M+1) gradations.

13. The amplification method according to claim 12,
wherein, in the step of performing the amplitude control,
the power amplifier core unit performs control in the (M+1) gradations to reproduce an envelope of an RF signal, and
average transmission power is controlled by using a combination of control on a number of unit amplifier groups to operate from among the L unit amplifier groups that are connected in parallel and the attenuation amount of the variable attenuator.

14. The amplification method according to claim 9, wherein a change in amplitude of an RF signal that corresponds to each gradation includes a portion that is not set at equal intervals.

15. The amplification method according to claim 12, wherein a change in amplitude of an RF signal that corresponds to each gradation in control in the (M+1) gradations includes a portion that is not set at equal intervals.

16. The amplification method according to claim 9, wherein the variable attenuator includes an output impedance matching circuit that has a function of an attenuator.

17. A transmitter comprising:
a phase-amplitude separation circuit that separates a baseband signal into a phase signal and an amplitude signal, the phase signal being a phase component of the baseband signal, the amplitude signal being an amplitude component of the baseband signal;
a phase modulation block that modulates an RF carrier signal with the phase signal to generate the RF carrier signal that has been phase-modulated;
a power amplifier core unit that is capable of performing amplitude control in discrete integer steps; and
a variable attenuator,
wherein the power amplifier core unit
modulates the RF carrier signal that has been phase-modulated, with the amplitude signal, to generate an RF signal that has been amplitude-modulated to have an envelope of a gradation including a plurality of levels, and
controls an average value of transmission power of the RF signal that has been amplitude-modulated to be any value of a predetermined integer number of average values, and
wherein, in a case where the predetermined integer number of average values are arranged in descending order, the variable attenuator is capable of changing an attenuation amount by a value that is smaller than a maximum value of a value expressing a difference between adjacent values in decibels.

18. The transmitter according to claim 17,
wherein, in the power amplifier core unit,
in a case where L and M are integers,
L unit amplifier groups are connected in parallel, the L unit amplifier groups being capable of performing control in (M+1) gradations, and
the average value of the transmission power is controlled to have L values, and
wherein the variable attenuator attenuates the transmission power to cause the average value of the transmission power to fall between at least one pair of the L arranged values.
